(19) United States
(12) Patent Application Publication
(10) Pub. No.: US 2019/0302574 A1
(43) Pub. Date: Oct. 3, 2019

(54) WATERPROOF CAMERA HOUSING

(71) Applicant: AquaTech (NSW) No. 2 Pty Ltd., Thirroul, NSW (AU)

(72) Inventor: Alan G. Love-Lapan, Austinmer (AU)

(73) Assignee: AquaTech (NSW) No. 2 Pty Ltd., Thirroul, NSW (AU)

(21) Appl. No.: 16/301,419

(22) PCT Filed: May 12, 2017
(86) PCT No.: PCT/AU2017/000105

§ 371 Date: Nov. 13, 2018

(30) Foreign Application Priority Data
May 13, 2016 (AU) 2016901777

(51) Int. Cl. G03B 17/08; G03B 17/56; G03B 17/12

(52) U.S. Cl. CPC G03B 17/08; G03B 17/12; G03B 17/563

(57) ABSTRACT

Disclosed herein is a waterproof camera housing comprising a base having a first end, a second end and a wall extending between said ends to define a chamber adapted to receive a camera. The base operates the camera when said camera is located within said camera chamber. An elongate lens housing having a first end and a second end, a wall extending between said ends to define a lens chamber and a longitudinal lens axis adapted to receive a lens to be connected to said camera. An attachment means secures said first end of said base to said second end of said lens housing so that said axis is perpendicular to said first end of said base. The attachment means provides a waterproof seal between said base and lens housing, and operates said lens when said lens is located within said lens chamber without breaking said waterproof seal.

### RELATED APPLICATIONS

This application claims priority to Patent Cooperation Treaty Application Serial No. PCT/AU2017/0000105 filed on 12 May 2017 which claims priority to Australian Provisional Patent Application No. 2016901777 filed on 13 May 2016, the entire contents of both applications which are herein incorporated by reference.

### FIELD OF THE INVENTION

The present invention relates to a waterproof camera housing and in particular to a waterproof camera housing having an extension tube for use with elongate zoom lenses and the like.

### BACKGROUND OF THE INVENTION

Cameramen have been taking cameras and lenses of all shapes and sizes to more extreme locations to obtain more amazing photographs. In this pursuit, cameras and lenses have been taken into environments where they can get wet. To ensure that cameras do not malfunction if they get wet, cameras have been fully encapsulated to ensure water does not penetrate into the internal workings of the camera. Such waterproof cameras however are limited to particular cameras, a fixed size and don't allow for flexibility of lenses, filters and the like.

In sport photography, such as surfing or the like, for example, it has been popular to utilise a waterproof housing which fits over different cameras to provide flexibility of cameras that can be used in water. However, such housings are bulky, a fixed size and make it difficult to use many of the camera settings whilst in the water. They also do not provide flexibility of use of camera lenses such as a zoom lens or the like.

In an attempt to address this issue, an extension lens tube has been glued to the camera housing. The main disadvantage with such systems is that a drive gear and lens gear must be used to operate manual focus and zoom function and the like. That is, you must penetrate through the wall of the camera housing or the lens tube, with the drive shaft/gear, to access the lens. This is both costly, a potential source of water and dirt ingression and generally unsightly.

Further, various attachments to camera housings, such as grips or handles, have been developed. However, they require one or more tools to install and remove the handle and the like. This is both time consuming, requires more parts, is an extra cost and mean tools must be carried with a cameraman which are potentially lost.

### OBJECT OF THE INVENTION

It is an object of the present invention to substantially overcome or at least ameliorate one or more of the disadvantages of the prior art, or to at least provide a useful alternative.

### SUMMARY OF INVENTION

There is disclosed herein a waterproof camera housing including a base having a first end and a second end and a wall extending between said ends to define a chamber. The chamber is adapted in use to receive a camera. The base having means to operate said camera when said camera is located within said camera chamber. An elongate lens housing having a first end and a second end, a wall extending between said ends to define a lens chamber and a longitudinal lens axis. The lens chamber is adapted in use to receive a lens to be connected to said camera in use. An attachment means to secure said first end of said base to said second end of said lens housing so that said axis is perpendicular to said first end of said base. The attachment means in use providing a waterproof seal between said base and lens housing, and means to operate said lens when said lens is located within said lens chamber without breaking said waterproof seal.

Additionally, in one embodiment, the housing includes a handle releasably securable to said base without the use of tools. Further, the handle includes an electronic pistol grip shutter release capability. Further, the handle includes a connector to connect to said camera operation means located on said base to thereby permit operation of said camera when said camera is secured within said camera chamber.

In another embodiment, the attachment means includes complimentary threads adjacent said first end of said base and said second end of said lens housing, said threads rotatably engageable to connect said base and lens housing together. Further, the attachment means includes at least one seal to provide a waterproof seal between said base and lens housing.

In an alternative embodiment, the second end of said lens housing includes opposing flanges, the flanges in use are adapted to receive said lens housing wall and permit said lens housing wall to rotate about said axis when manipulated by a user. The flanges include a pair of rings, engageable in use with a pair of circular seals to connect said base to said lens housing in a waterproof manner.

In one embodiment, the lens housing wall is rotatable about 60 degrees clockwise or anti-clockwise about said axis.

In an alternative embodiment, the lens housing includes a transfer portion. The transfer portion is located on said lens housing wall and extending into said lens chamber, said transfer portion adapted to connect with a lens located in said lens chamber in use and transfer rotation of said lens housing by a user to rotation of the lens within said lens chamber without breaking a waterproof seal.

In another embodiment, the handle includes a locking mechanism to lock said handle to said base. The locking mechanism includes a spring loaded pin.

In a further embodiment, the waterproof camera housing is also sound proof in use.

### BRIEF DESCRIPTION OF DRAWINGS

A detailed description of some embodiments of the invention is made below with reference to the accompanying figures, wherein like numerals represent corresponding parts of the figures.

FIG. 1 is a left side view of an embodiment of the present invention;

FIG. 2 is a parts disassembled view of the embodiment of FIG. 1;

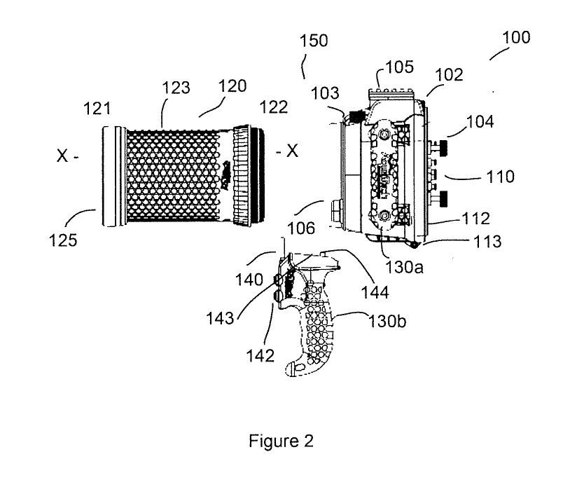

FIG. 3 is a front view of an embodiment of the present invention;

FIG. 4 is a sectioned view along line A-A of FIG. 3;

FIG. 5 is a disassembled view of the lens housing;

FIG. 6 is a parts disassembled view of the present invention of FIG. 1;

FIG. 7 is a detailed view of the sealing arrangement shown in FIG. 4.

### DESCRIPTION OF EMBODIMENTS

In the drawings there is disclosed a waterproof camera housing 100 which includes a base 102 having a first end 103 and a second end 104 and a wall 105 extending between the ends 103, 104 to define a chamber 106. The camera chamber 106 is adapted in use to receive a camera (not shown). The camera could be mounted within the camera chamber 106 by attachment to various attachment means, for example, lugs, fasteners or the like (not shown) depending upon the type of camera used. Typically, cameras are mounted to a camera slide plate via the camera tripod mounting thread. The camera slide plates are of a specific shape, for each camera model, to fit the bottom of the camera to locate the camera inside the base 102 securely. These camera slide plates (not shown) then slide into a corresponding female dovetail groove in the base 102.

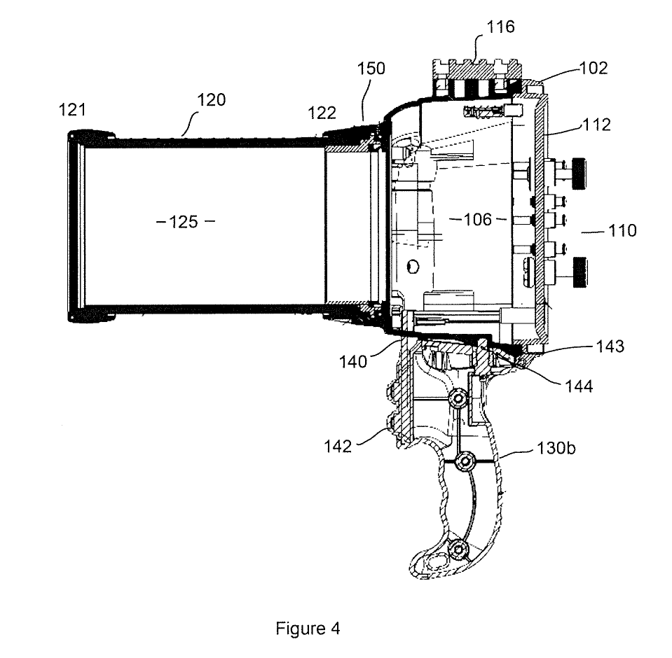

The base 102 includes means 110 to operate the camera when the camera is located within the camera chamber 106. Those camera operation means 110 are shown in the drawings as mechanical type buttons as best seen in FIG. 4 which are preferably located on a back plate or cover 112 enclosing the camera chamber 106. That back plate 112 can come in various shapes and sizes having different configurations of operation means buttons 110 depending upon the type of camera to be located within the camera chamber 106.

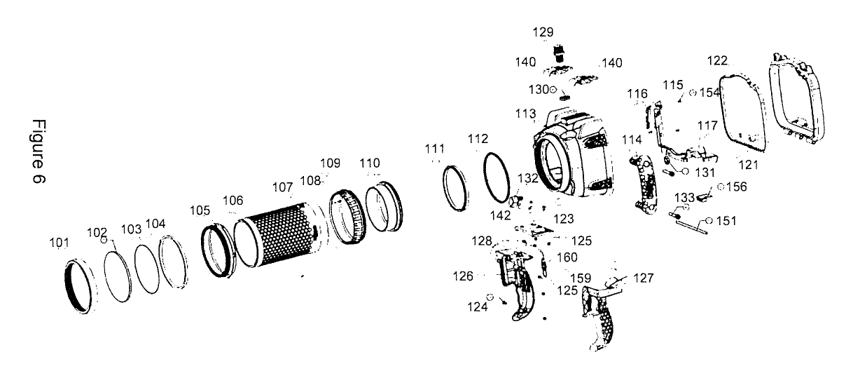

Typically, these buttons 110 are either an actuation or dial type system both of which require a gland system for sealing. This is discussed later in respect of FIG. 6. The gland is a threaded part that screws into a corresponding thread with a machined chamfer that accepts an O-ring. This O-ring in on the top of the Gland. Down the center of the gland either a push shaft or smooth turning shaft seal allows access, by the user, to the camera and lens from the outside of the base 102.

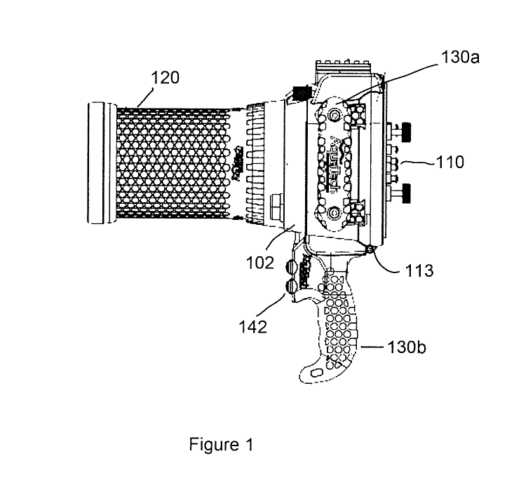

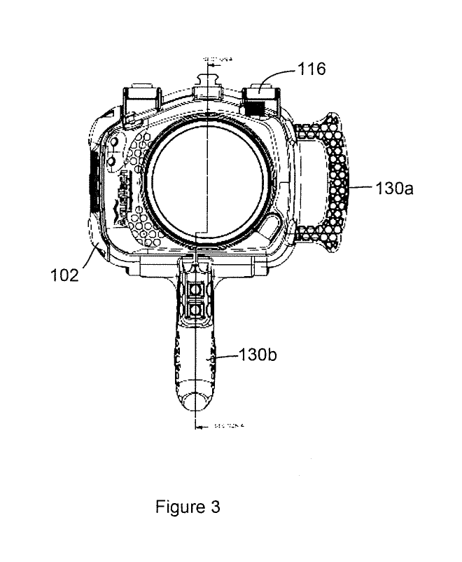

The back plate 112 can also include windows (not shown); touch screen material or the like to assist with operation of the camera within the camera chamber 106. The back plate 112 can be connected to the base 102 by way of a hinge 113 (see FIG. 1) and/or other locking mechanisms such as a pin 114, snap locks 116 (see FIG. 3) or the like. On typical systems, a series of bolts using a tool, wing nuts or clamps will hold down either a front plate or back plate 112.

The camera housing 100 further includes an elongate lens housing 120 having a first end 121 and a second end 122. A lens housing wall 123 extends between the ends 121, 122 to define a lens chamber 125 and a longitudinal axis XX. The lens chamber 125 is adapted in use to receive a camera lens (not shown) which in use is to be connected to a camera.

The camera housing 100 further includes attachment means 150 to secure the first end 103 of the base 102 to the second end 122 of the lens housing 120 so that the axis XX is perpendicular to the first end 103 of the base 102. The attachment means 150 in use provides a waterproof seal between the base 102 and housing 120. The housing 120 further includes means to operate the lens when the lens is located within the lens chamber 125.\

In an alternate embodiment and as best seen in FIG. 3, the camera housing 100 can include a handle 130. The handle 130 can come in various forms and be fixedly secured to the base 102 or releasably securable to the base 102. In FIG. 3, two types of handles 130 are shown. One is a fixed side handle 130a and one is a bottom releasable handle in a form of pistol grip 130b. The housing 100 could include any number of handles 130. As best seen in FIG. 4, when the handle 130 is in the form of a pistol grip 130b it includes a connector 140 to connect the camera operation means 110 located in the base 102 to thereby permit operation of the camera when the camera is secured within the camera chamber 106. In this particular embodiment shown, buttons 142 are provided on the pistol grip 130b which connect via connection means 140 to the camera. The pistol grip 130b is releasably securable to the base 102 by way of a dovetail joint 143 and includes a locking means having a pin 144 and whole system to lock the pistol grip 130b to the base 102 without the need for tools or the like. It should be appreciated that though a dovetail joint is shown, various other forms of connectors could be used.

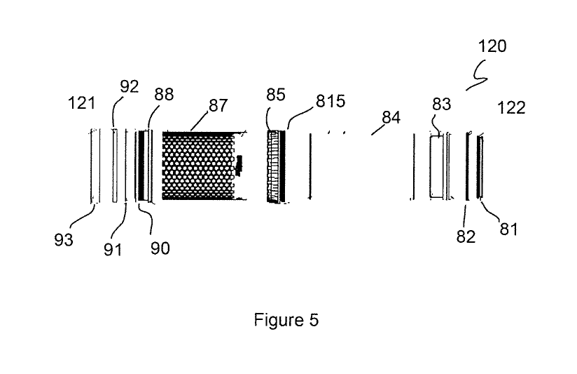

An alternative embodiment of the lens housing 120 is shown in FIG. 5 where starting from the second end 122 there is shown an adaptor ring inside seal 81, adaptor ring outside seal 82 which has a trap fitted to a spin adaptor 83 which is solvent welded to a port and tube extruded section 84. A Port Rear Joining Ring 85 fits over the extruded section 84 and is fitted to the second end 122 so that the threaded sections 815 can be connected to the base 102 and allow the extruded section 84 to rotate. A port & tube rubber sleeve 87 is provided for grip and appeal over the extended section 84. A port & tube front lens ring 88 is solvent sealed to the other end of the extruded section 84. A front o-ring port & tube seal 90, port and tube PMMA Lens 91, port & tube front lens ring compression moulded insert 92 and port & tube front clamp ring 93 seal off the end 121 and provide a further mount for rotation of the extruded section 84. In an embodiment there may be nothing between the PMMA lens element 91 and the outside capture ring 93.

In FIG. 6, there is shown a disassembled embodiment of the present invention, including a port & tube front clamp ring 101, port and tube PMMA lens 102, port and tube lens ring O-ring 103, port & tube lens ring compression moulded insert 104, port & tube front lens ring 105, extrusion moulded tube 106, port & tube rubber sleeve 107, port rear joining ring 108, port & tube rear joining ring over mould 109, adaptor 110, adaptor ring inside seal 111, adaptor outside seal 112, axis front housing 113, axis side handle 114, axis dual switch PCB support bracket 115, main housing rigger PCB 116 gets screwed to the inside of the main body to hide wiring from 2 button switches and from the bulkhead connector, inside skin 117 with 115 can be one piece), rubber buffer plug 121, axis silicon wedge seal 122, top cover for pistol grip 123, button head M4 machine screw 124, PEM M4 IUC code 1 stainless steel insert 125, 2 button control overmoulded switch 126, pistol grip left 127, pistol grip right 128, flash bulk head 6 pin 129, flash BH nut 130, hex jam nut 131, 3 pin pistol bulk head 132, latch 140, 19427 housing 304SS Passivated 142, Chicago pin 151, 3.5 right angle mate converter 152, M6×35 long SHCS 153, M4×3 mm stainless steel dome head cap screw 154, PEMM M3×5.56 IUC length code 2 stainless steel insert 155, AQT-944-700 PCB connection board 156, M6×1 18C-8.73 long 158 being the thread pitch on the spring plunger body 159, 160 (part to the pistol grip locking it into the main body), 50593 push pin 167, circlip 168, spring 169 inside the spring plunger.

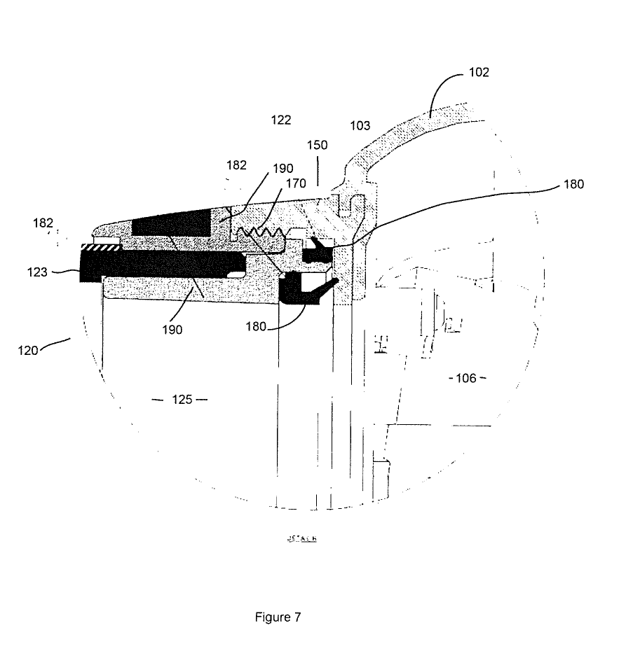

As best seen in FIG. 7, the attachment means 150 includes complimentary threads 170 located on the first end 103 of the base 102 and the second end 122 of the lens housing 120. The threads 170 are adapted to be screwed together to connect the base 102 and lens housing 120. However, it should be understood that rather than threads 170, a snap-locking engagement or other such fastening means could be utilized. To ensure a watertight seal, one or more seals 180 should be provided.

In FIG. 7, the lens housing 120 adjacent the second end 122 includes a pair of flanges 190, 191 between which the wall 123 can be located. The flanges 190, 191 are adapted in use to permit the lens housing wall 123 to rotate about the lens axis XX when manipulated by a user whilst maintaining a waterproof seal. In an alternate form, the lens housing wall 123 would be rotatable about 60 degrees clockwise or anti-clockwise about the lens axis XX. It should however be appreciated that other rotation angles could be achieved. The lens housing 120 includes a transfer portion (not shown) located on the lens housing wall 123 and extending into the lens chamber 125. The transfer portion is adapted to connect with a lens located in the lens chamber 125 and transfer rotation of the lens housing 120 by a user to rotation of the lens within the lens chamber 125 without breaking the waterproof seal. This also means that there is no requirement for penetrating through the wall 123 of the housing or lens port tube 120 to access the lenses manual focus or zoom function. The user simply turns the tube 123 from the outside of the housing 120 like they would a lens if using camera on land or without the camera and lens inside of the housing 120.

The transfer portion in an embodiment will be a glued-in, hook and loop fastened, snap locked or the like soft material (such as foam, rubber, sponge or the like) to the inside of each relevant lens port that will line up and grip the lenses zoom rubber ring or focus rubber ring and allow the user to turn these functions from the outside of the lens port housing. It will vary in size for different lens diameters and could be integrally formed or removable. The transfer portion is thus located on said lens housing wall and extending into said lens chamber, said transfer portion adapted to connect with a lens located in said lens chamber in use and transfer rotation of said lens housing by a user to rotation of the lens within said lens chamber without breaking a waterproof seal.

The arrows 182 in FIG. 10 show the direction of water flow through the system. The attachment means configuration directs water away from the inside chambers 106, 125. The inside wedge seal 180 and outside wedge seal 180 work together to ensure a water tight closure end to ensure the seal adapter plate 191 connects into the housing front part flange 190.

In a further embodiment, a software/app could be developed which would offers tools within an app or existing software that will use an algorithm to remove minor water drops from the front ports or first end 121 of the lens housing 120 (or any camera/housing in the water) in post processing. Many photographers work on top of the water not underwater, and water drops can ruin a significant number of good photographs.

Persons of ordinary skill in the art may appreciate that numerous design configurations may be possible to enjoy the functional benefits of the inventive systems. Thus, given the wide variety of configurations and arrangements of embodiments of the present invention the scope of the invention is reflected by the breadth of the claims below rather than narrowed by the embodiments described above.

I claim:

1. A waterproof camera housing including:
a base having a first end and a second end and a wall extending between said ends to define a chamber, said chamber adapted in use to receive a camera;
said base having at least one button to operate said camera when said camera is located within said camera chamber;
an elongate lens housing having a first end and a second end, a wall extending between said ends to define a lens chamber and a longitudinal lens axis, said lens chamber adapted in use to receive a lens to be connected to said camera in use;
a connector to secure said first end of said base to said second end of said lens housing so that said axis is perpendicular to said first end of said base;
said connector in use providing a waterproof seal between said base and lens housing; and
a transfer portion to operate said lens when said lens is located within said lens chamber without breaking said waterproof seal.

2. The waterproof camera housing of claim 1 including a handle releasably securable to said base without the use of tools.

3. The waterproof camera housing of claim 2, wherein said handle includes an electronic pistol grip shutter release capability.

4. The waterproof camera housing of claim 3, wherein said connector is in communication with said at least one button located on said base to thereby permit operation of said camera when said camera is secured within said camera chamber.

5. The waterproof camera housing of claim 1, wherein said connector includes complimentary threads adjacent said first end of said base and said second end of said lens housing, said threads rotatably engageable to connect said base and lens housing together.

6. The waterproof camera housing of claim 5, wherein said connector includes at least one seal to provide a waterproof seal between said base and lens housing.

7. The waterproof camera housing of claim 1, wherein said second end of said lens housing includes opposing flanges, said flanges in use are adapted to receive said lens housing wall and permit said lens housing wall to rotate about said axis when manipulated by a user.

8. The waterproof camera housing of claim 1, said flanges include a pair of rings, engageable in use with a pair of circular seals to connect said base to said lens housing in a waterproof manner.

9. The waterproof camera housing of claim 1, wherein the lens housing wall is rotatable about 60 degrees clockwise or anti-clockwise about said axis.

10. The waterproof camera housing of claim 1, wherein said transfer portion is located on said lens housing wall and extending into said lens chamber, said transfer portion adapted to connect with a lens located in said lens chamber in use and transfer rotation of said lens housing by a user to rotation of the lens within said lens chamber without breaking a waterproof seal.

11. The waterproof camera housing of claim 3, wherein said handle includes a locking mechanism to lock said handle to said base.

12. The waterproof camera housing of claim 11, said locking mechanism includes a spring loaded pin.

13. The waterproof camera housing of claim 1, wherein said waterproof camera housing is also sound proof in use.
